(19) United States
(12) Patent Application Publication
(10) Pub. No.: US 2004/0049511 A1
(43) Pub. Date: Mar. 11, 2004

(54) Method for acquiring and monitoring hardware data of computer system

(76) Inventor: Wen-Chu Yu, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/418,161

(22) Filed: Apr. 18, 2003

(30) Foreign Application Priority Data
Sep. 5, 2002 (TW) 91120238

(51) Int. Cl. G06F 7/00

(52) U.S. Cl. 707/100

(57) ABSTRACT

A method for acquiring and monitoring hardware data of a computer system is disclosed, which executes a hardware monitoring program to acquire data of selected hardware device from an associated input/output port of the computer system. The method includes reading an user interface definition file by the hardware monitoring program, the user interface definition file containing a number of pre-defined input/output device control sections each containing execution functions and set parameters of each particular input/output device; and the hardware monitoring program communicating with the input/output device via an input/output control file, the input/output control file performing functions of “open input/output port”, “read input/output port” and “write input/output port” to access the input/output port in order to acquire the data of the input/output device of the computer system.

### BACKGROUND OF THE INVENTION

1. Field of the Invention

The present invention relates generally to a method for monitoring hardware of computer system, and in particular to a method for acquiring and monitoring data of input/output devices of a computer system operating under a “Windows” based operating system.

2. The Related Art

Computer devices, such as desktop computers and notebook computers, are the most commonly used office automation equipment, which are often used in letter drafting, documentation, database establishment and search, engineering design, accounting operation, and data communication. The quick development of the computers makes computer-related hardware upgraded from time to time and the “old” hardware simply gets out of market. The computer software, such as operating system, is being developed and improved with the development of the hardware simultaneously. The computer operating system has been evolving from DOS to Windows based operating systems, such as Windows 98 Windows Me Windows 2000 and Windows XP, and the “DOS” based computer system is rarely used nowadays.

Although “DOS” has been replaced by “Windows” based operating systems, some of the basic functions of “DOS” are applied in some of the “Windows” based operating systems to allow a computer operator or engineer to properly monitor input/output devices of a computer system. Thus, the computer engineer can recognize the operation situation of the input/output device of the computer system.

The input/output devices of a computer system communicate with a host machine of the computer system via an interface circuit, which comprises a set of registers, named input/output ports, serving as communication ports between a central processing unit or memory of the host machine and the input/output devices. The input/output ports are categorized as “data port”, “status port” and “control port”, and each I/O port has its own port address.

In the early version of “DOS” operating system or “Windows 98” operating system, a computer engineer may acquire the data of an input/output device of a computer system under the “DOS” or “Windows 98” operating system by means of commands provided in “DOS” operating system. This handy way provides the computer engineer with an easy measure to “get aware of” the data and situation of the input/output devices. However, the currently prevailing “Windows 2000” and “Windows XP” operating systems do not support any “DOS” based commands and thus the handy way for the communication between the computer engineer and the input/output devices is no longer present. Further, the “Windows” based operating systems themselves do not provide the computer engineer with individual user interface. Thus, there is completely no way for the computer engineer to acquire the data of the input/output devices.

### SUMMARY OF THE INVENTION

Thus, a primary object of the present invention is to provide a method for acquiring and monitoring hardware data of a computer system, which allows for acquiring and monitoring data of an input/output device of the computer system operating under the “Windows” based operating systems.

Another object of the present invention is to provide a method for acquiring and monitoring hardware data of a computer system, which executes a hardware monitoring program to communicate with hardware devices of a computer system via drivers of the operating system of the computer system in order to monitor and acquire data associated with the hardware device of the computer system.

To achieve the above objects, in accordance with the present invention, a method for acquiring and monitoring hardware data is provided, which executes a hardware monitoring program for reading a user interface definition file. The user interface definition file contains a number of pre-defined input/output device control sections, each containing execution functions and set parameters of a particular input/output device. The hardware monitoring program performs communication with the designated input/output device by means of an input/output control file and thus acquires data of the input/output device. The input/output control file accesses the designated input/output device by opening input/output ports, reading the input/output ports and writing the input/output ports.

Preferably, the user interface definition file is defined by a computer user in accordance with his or her personal requirements. In addition, the method of acquiring and monitoring hardware data in accordance with the present invention allows for display of the acquired hardware data on a display device of the computer system. Such data can also be stored in a destination file previously designated in the computer system to serve as a source for error detection and diagnosis in future operation of the computer system.

### BRIEF DESCRIPTION OF THE DRAWINGS

The present invention will be apparent to those skilled in the art by reading the following description of the best mode for carrying out the invention, with reference to the attached drawings, in which:

FIG. 1 is a block diagram of a computer system in which a method for acquiring and monitoring hardware data of the computer system in accordance with the present invention is embodied;

FIG. 2 is a flowchart of a first embodiment of the method for acquiring and monitoring hardware data of the computer system in accordance with present invention;

FIG. 3 is an example of a display image on a display device by the method of the present invention; and

FIG. 4 is a flowchart of another embodiment of the method in accordance with the present invention.

### DETAILED DESCRIPTION OF THE PREFERRED EMBODIMENTS

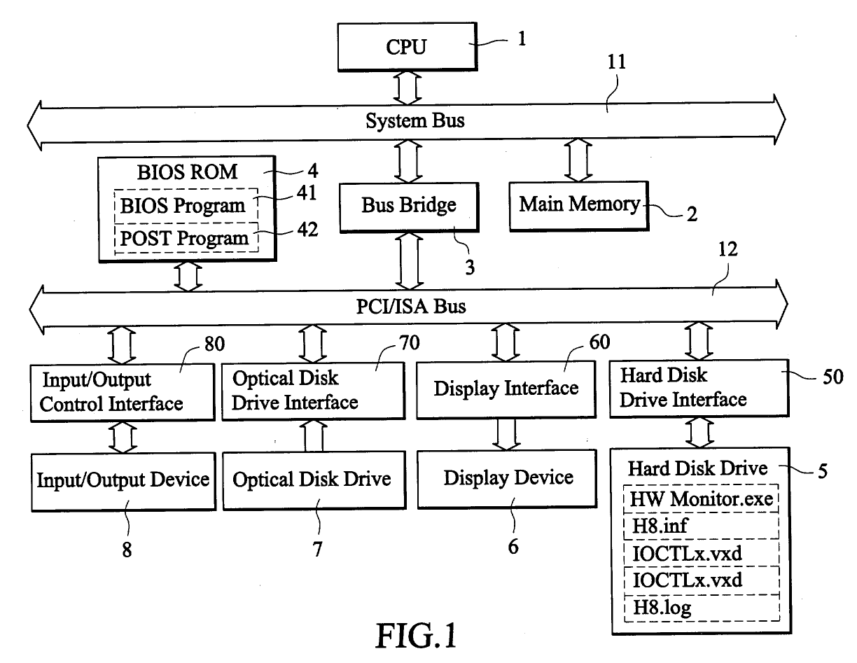

With reference to the drawings and in particular to FIG. 1, a computer system in which a method for acquiring and monitoring hardware data of the computer system in accordance with the present invention is embodied is shown. The computer system is comprised of typical computer components and peripheral devices, including a central processing unit (CPU) 1, a main memory 2, a bus bridge 3, a Basic Input and Output System Read Only Memory (commonly referred to as BIOS ROM) 4, a hard disk drive 5, a display device 6, an optical disk drive 7 and input/output device 8. The central processing unit 1 is connected to the main memory 2 via a system bus 11, which comprises address bus, data bus and control bus. The system bus 11 is connected to a PCI/ISA bus 12 by the bus bridge 3. The BIOS ROM 4 contains BIOS program 41 and Power On Self Test (POST) program 42. The hard disk drive 5 is connected to the PCI/ISA bus 12 via a hard disk interface 50, such as an IDE interface. The display device 6 is connected to the PCI/ISA bus 12 via a display interface 60. The optical disk drive 7 is connected to the PCI/ISA bus 12 via an optic disk interface 70. The input/output devices 8, such as a keyboard, a computer mouse and a joystick, are coupled to the PCI/ISA bus 12 by input/output control interfaces 80.

In accordance with the present invention, to communicate with an input/output device of the computer system, a hardware monitoring program, named HW Monitor.exe, is provided and stored in the hard disk drive 5. In addition, a user interface definition file, named H8.inf, and an input/output control file, named IOCTLx.vxd (for “Windows 98” operating system) or IOCTLx.sys (for “Windows Me”, “Windows 2000” and “Windows XP” operating systems), are also provided and stored in the hard disk drive 5, with reference to FIG. 1. The currently preferred embodiment of the present invention is implemented for operation in known windows operating system, such as “Windows 98”, “Windows Me”, “Windows 2000” and “Windows XP”, all available from Microsoft Corporation.

It is apparent that the hardware monitoring program (HW Monitor.exe), the user interface definition file (H8.inf) and the input/output control file (IOCTLx.vxd or IOCTLx.sys) can be stored in other recording medium, such as an optical disk (not shown) which can be accessed by means of the optical disk drive 7 or other proper accessing device.

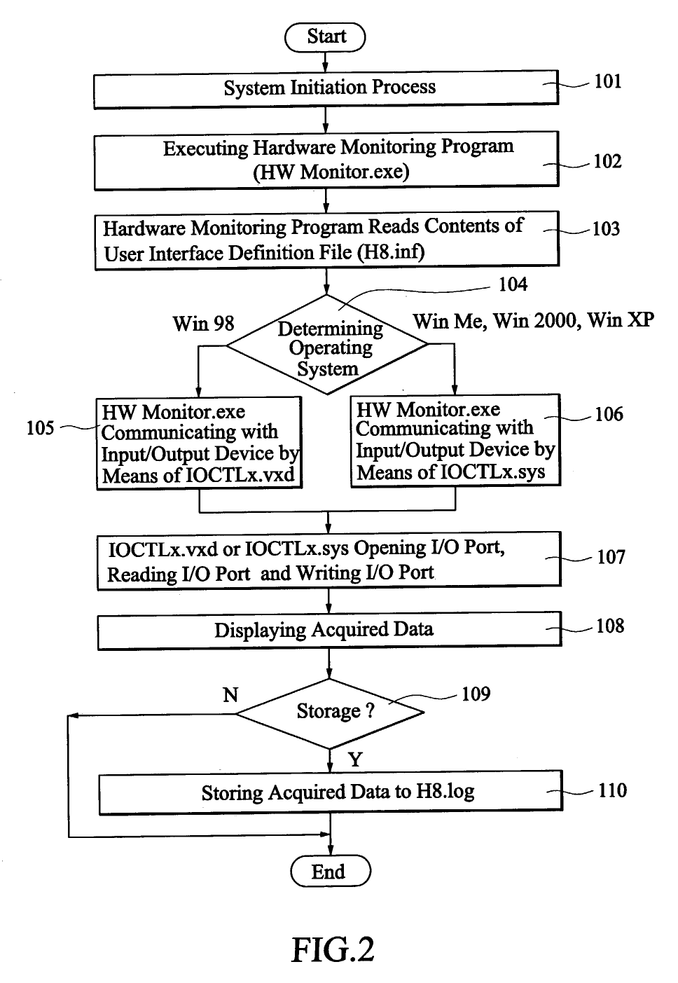

Also referring to FIG. 2, a flowchart for performing the method for acquiring and monitoring hardware data in accordance with a first embodiment of the present invention is shown. The method starts with a system initiation process, step 101, which performs system test, basic input/output system (BIOS) test, power on self test (POST), loading of operating system and other standard initiation process of a computer system. The operating system loaded into the computer system in step 101 is for example an “Windows 98”, “Window Me”, “Windows 2000” or “Windows XP” operating system.

After the system initiation process (namely step 101), the method goes to step 102 in which the hardware monitoring program (HW Monitor.exe) that is stored in the hard disk drive 5 is performed. In step 103, the hardware monitoring program reads the contents of the user interface definition file (namely H8.inf) that is stored in the hard disk drive 5. In accordance with the present invention, the user interface definition file (H8.inf) contains a number of input/output device control sections that are pre-defined in association with each input/output device of the computer system and contain execution functions of the input/output devices, such as:

(1) outputting data to designated input/output ports;

(2) outputting data stored in an internal register of the computer system to the designated input/output ports;

(3) reading data from the designated input/output ports;

(4) waiting time;

(5) storing data of the internal register to a register array and indexing data;

(6) performing a logic AND operation on data of the internal registers and storing the operation result to a register;

(7) performing a logic OR operation on data of the internal registers and storing the operation result to an internal register;

(8) performing a logic XOR operation on data of the internal registers and storing the operation result to an internal register;

(9) loading the register array and indexing data to internal register;

(10) depositing the internal register in a feedback buffer; and

(11) depositing the internal register and indexing data in the feedback buffer.

Thus, after the hardware monitoring program (HW Monitor.exe) reads the contents of the user interface definition file (H8.inf), the hardware monitoring program performs the execution functions recorded in each pre-defined input/output device control section of the user interface definition file.

In step 104, the operating system of the computer, under which the computer system is operating, is determined to find out the type of the operating system. This allows the hardware monitoring program of the present invention to communicate with the input/output devices of the computer system via the operating system of the computer system with a properly selected input/output control file, such as IOCTLx.vxd or IOCTLx.sys. As mentioned previously, for “Windows 98” based computer system, the hardware monitoring program communicates with the input/output devices that are coupled to the computer system via the input/output control file-IOCTLx.vxd (step 105). If the operating system of the computer system is “Windows Me”, “Windows 2000” or “Windows XP”, then the hardware monitoring program communicates with the input/output devices via the input/output control file-IOCTLx.sys (step 106).

The input/output control file, either IOCTLx.vxd or IOCTLx.sys, performs functions of “open input/output port”, “read input/output port” and “write input/output port” and other functions to communicate with the designated input/output device via the associated input/output ports (step 107) and acquire data and information of the input/output device. The data obtained from the input/output ports are then displayed on the display device 6 (step 108) for visual inspection by a computer engineer or operator. These data may then be used in for example error detection and computer diagnosis.

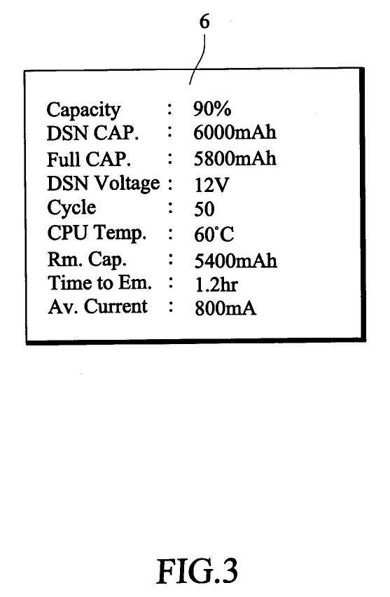

FIG. 3 shows an example display of the data acquired from the input/output ports in accordance with the present invention, which may comprise:

(1) Battery Capacity: such as 90% full;

(2) Original Design Battery Capacity (DSN CAP.): such as the original design battery capacity is 6000 mAh;

(3) Full Battery Capacity (Full CAP.): such as the full battery capacity is 5800 mAh;

(4) Original Design Battery Voltage (DSN Voltage): such as the original design rated voltage is 12V;

(5) Charge/discharge Cycle: such as 50 cycles of charge and discharge to the Battery;

(6) Central Processing Unit Temperature (CPU Temp.): such as the current temperature of the CPU is 60° C.;

(7) Remaining Capacity of Battery (Rm. Cap.): such as an estimation of the remaining capacity of the battery is 5400 mAh;

(8) Time to Exhaustion of Battery (Time to Em.): such as an estimation of the time to exhaustion of the battery is 1.2 hr; and

(9) Average Current of Battery (Av. Current): such as the electric current supplied by the battery is 800 mA.

The method of the present invention further comprises a step of confirmation of storing the data, step 109. If it is desired to store the acquired data, then in step 110, the data are stored in a designated file, which is named H8.log in the embodiment illustrated. This allows for future inspection of the data.

In accordance with the present invention, the user interface definition file-H8.inf is preferably defined by the computer user or operator. This allows each computer user to build up his or her own user interface definition file to form a customized user interface definition file that meets the user's personal requirements.

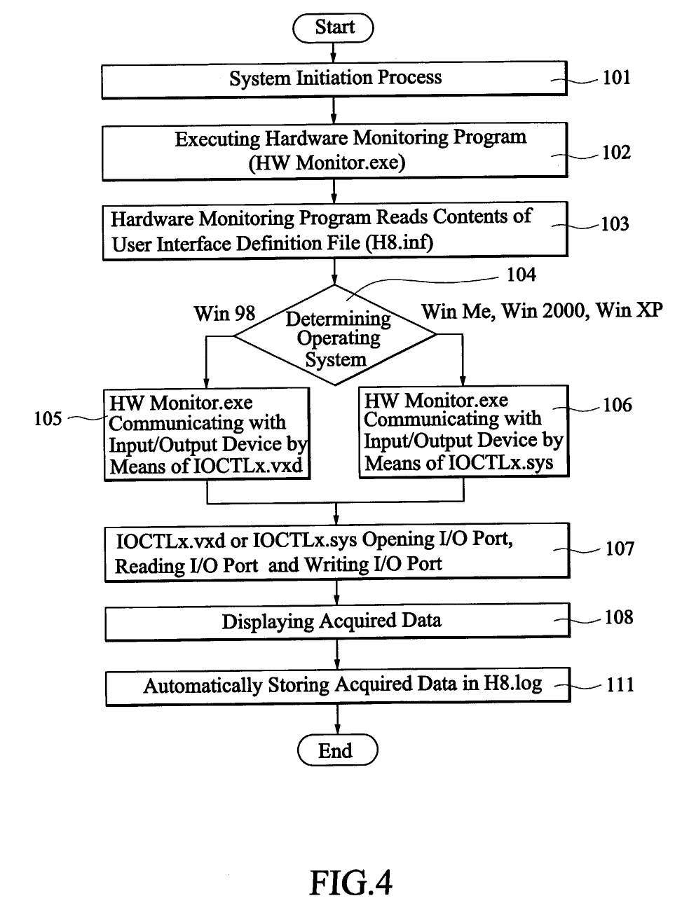

FIG. 4 shows another embodiment of the present invention, wherein steps 101-108 are exactly the same as those used in the previous embodiment illustrated in FIG. 2. The storage associated steps, step 109 and step 110, are replaced by an automatic storage step, step 111. In other words, after the data are acquired (namely after step 108), the method automatically stores the acquired data in for example 30 seconds later to the designated file-H8.log.

By means of the method of the present invention, the computer user or engineer can directly communicate with the input/output devices via the drivers of the operating system and cross-platform operation can be performed by using the input/output control file (IOCTLx.vxd and IOCTLx.sys) for directly acquiring and monitoring data of input/output devices in different “Windows” based operating systems without installation of additional drivers.

Although the present invention has been described with reference to the best modes of operation thereof, it is apparent to those skilled in the art that a variety of modifications and changes may be made without departing from the scope of the present invention which is intended to be defined by the appended claims.

What is claimed is:

1. A method for acquiring and monitoring data of at least one selected input/output device coupled to a computer system operating under a Windows based operating system, the method comprising the following steps:
(a) accessing a recording medium containing a hardware monitoring program to read and execute the hardware monitoring program;
(b) the hardware monitoring program reading a user interface definition file which contains a number of pre-defined input/output device control sections, each section comprising execution functions and set parameters of each selected input/output device; and
(c) the hardware monitoring program communicating with the selected input/output device that is coupled to the computer system via an input/output control file which performs functions of “open input/output port”, “read input/output port” and “write input/output port” to access associated input/output ports for acquiring data of the input/output device of the computer system.

2. The method as claimed in claim 1, wherein the recording medium comprises a hard disk drive in which the hardware monitoring program, the user interface definition file and the input/output control file are stored.

3. The method as claimed in claim 1, wherein the recording medium comprises an optical disk in which the hardware monitoring program, the user interface definition file and the input/output control file are stored.

4. The method as claimed in claim 1, wherein the user interface definition file is defined by a computer user of the computer system.

5. The method as claimed in claim 1 further comprising a step of determining the operating system of the computer system before step (c) in order to allow the hardware monitoring program to work with properly selected input/output control file for acquiring the data of the input/output device.

6. The method as claimed in claim 1 further comprising a displaying step of displaying the acquired data on a display device by the hardware monitoring program.

7. The method as claimed in claim 6 further comprising a storage step of automatically storing the acquired data in a designated file after the displaying step.

8. The method as claimed in claim 7 further comprising a step of confirmation for storing the acquired data before the storage step.
